(19) United States
(12) Patent Application Publication
(10) Pub. No.: US 2026/0163408 A1
(43) Pub. Date: Jun. 11, 2026

(54) Wireless Power Delivery in a Fluid Environment

(71) Applicant: Disney Enterprises, Inc., Burbank, CA (US)

(72) Inventor: Daniel Mark Joseph, Burbank, CA (US)

(21) Appl. No.: 18/970,483

(22) Filed: Dec. 5, 2024

(51) Int. Cl. H02J 50/10; F21L 4/08; F21V 23/02; H02J 50/40; H05B 47/19

(52) U.S. Cl. CPC H02J 50/10; F21L 4/08; F21V 23/02; H02J 50/40; H05B 47/19

(57) ABSTRACT

A system includes a reservoir containing a fluid, one or more objects in physical contact with the fluid, each of the one or more objects having a respective induction coil embedded therein, at least one conductive coil in the reservoir, and a control device having a hardware processor and a memory storing a control application. The hardware processor is configured to execute the control application to receive an input to initiate an activity using the one or more objects and provide, in response to receiving the input, a first electric current in the at least one conductive coil. Wherein each of the one or more objects is powered by a respective second electric current generated in the respective induction coil of each of the one or more objects, in response to the first electric current, to perform the activity.

### BACKGROUND

The enjoyment of visitors to water-based attractions such as fountains and artificial lagoons, for example, can be enhanced by the presence of objects such as self-propelled watercraft and submergible synthetic fish and other aquatic lifeforms that appear to be bioluminescent. Safely providing the power required to enable those objects to move or glow has presented a challenge, particularly in environments in which many objects are to be in use and conventional solutions fail to scale adequately.

For example, one approach to producing moving light effects in water involves enclosing a light source powered by a small coin or button battery in a ping pong ball type object. This approach can result in a pleasing visual effect when many such objects are used together, but because the power is inside each object and must typically be manually turned on, it is very labor intensive to do so, while the batteries used in this approach have finite life and require periodic replacement.

Another existing approach to powering objects in water is to introduce live alternating current (A/C) electricity directly into the water. However, this approach requires the objects receiving the electric power to have exposed metal leads, and due to significant safety concerns, can only realistically be implemented at a small scale in carefully controlled environments. Consequently, there remains a need in the art for a safe and scalable solution for delivering power to objects in a fluid environment.

### BRIEF DESCRIPTION OF THE DRAWINGS

FIG. 1A shows a diagram of a system configured to wirelessly deliver power to objects in a fluid environment, according to one exemplary implementation;

FIG. 1B shows a diagram of a system configured to wirelessly deliver power to objects in a fluid environment, according to another exemplary implementation;

FIG. 2 shows a more detailed diagram of an exemplary object configured to receive power in the systems of FIGS. 1A and 1B, according to one implementation;

FIG. 3 shows a more detailed diagram of a control device suitable for use in the systems of FIGS. 1A and 1B, according to one implementation; and

FIG. 4 shows a flowchart presenting an exemplary method for use by a system to wirelessly deliver power to objects in a fluid environment, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As stated above, the enjoyment of visitors to water-based attractions such as fountains and artificial lagoons can be enhanced by the presence of objects such as self-propelled watercraft and submergible synthetic fish and other aquatic lifeforms that appear to be bioluminescent. However, and as described above, safely providing the power required to enable those objects to move or glow has presented a challenge, particularly in environments in which many objects are to be in use and conventional solutions fail to scale adequately.

The present application is directed to a safe and scalable solution for delivering power to objects in a fluid environment, such as a small water basin to a large lake, that addresses and overcomes the deficiencies in the conventional art. The novel and inventive concepts disclosed in the present application advance the state-of-the-art by providing a wireless power delivery solution using a primary current in one or more conductive coils of a reservoir containing a fluid to induce a secondary current in a respective induction coil embedded in each object receiving power. That induced current can be safely utilized to illuminate a light source embedded in the object, activate a propulsion device of the object, or illuminate and propel the object in the fluid. Moreover, the present solution may advantageously be implemented as substantially automated systems and methods. The term “fluid” as used in the present application encompasses fluids and/or gasses. However, in various implementations discussed below, the fluid environment may include a liquid or be a liquid only. The term “liquid” does not include gases, and “liquid” has at least one of a fixed volume or a fixed shape.

As defined in the present application, the terms “automation,” “automated” and “automating” refer to systems and processes that do not require human intervention. Although in some implementations a human operator may supervise the systems using the methods described herein, that human involvement is optional. Thus, the methods described in the present application may be performed under the control of hardware processing components of the disclosed automated systems.

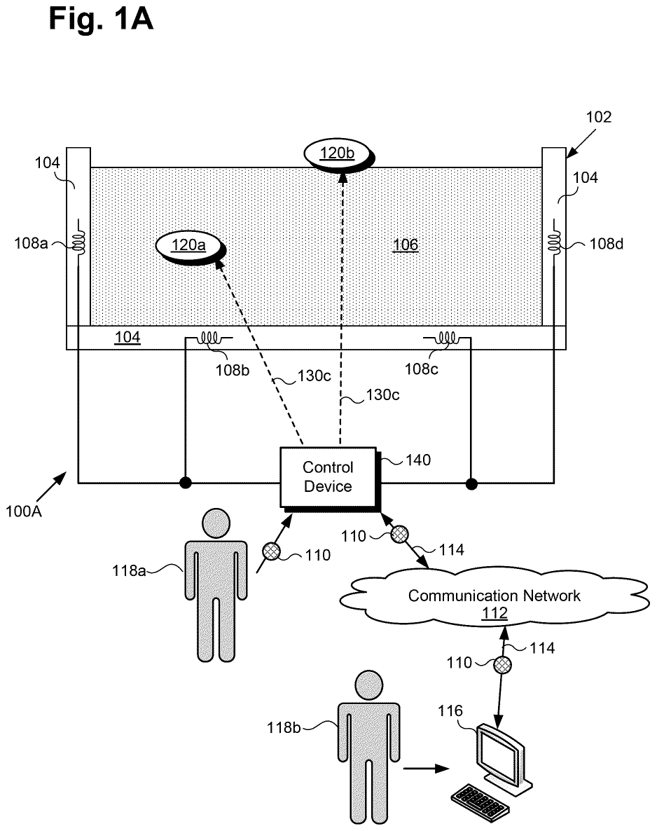

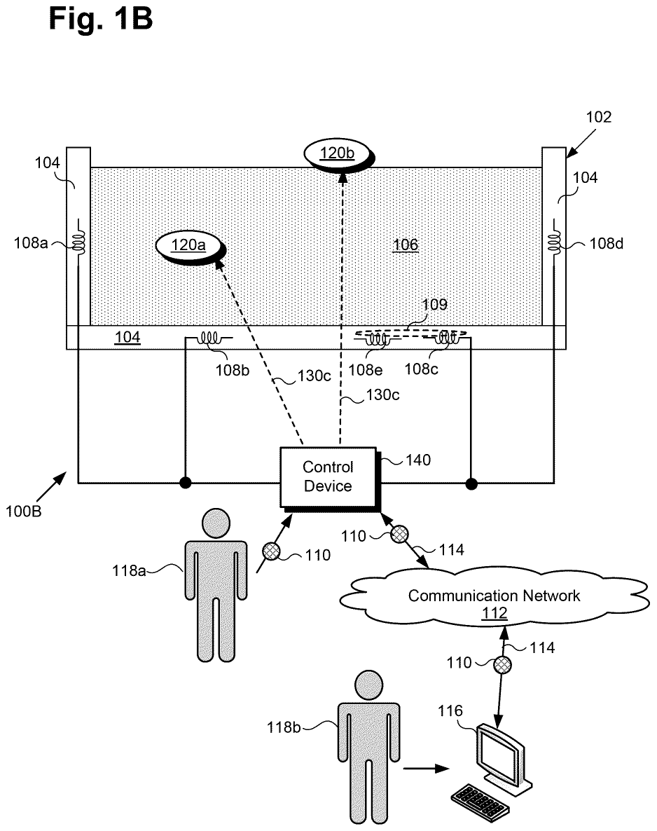

FIG. 1A shows a diagram of system 100A configured to wirelessly deliver power to objects in a fluid environment, according to one exemplary implementation. As shown in FIG. 1A, system 100A includes reservoir 102 containing fluid 106, one or more objects 120a and 120b (hereinafter “object(s) 120a/120b”) in physical contact with fluid 106, conductive coils 108a, 108b, 108c and 108d (hereinafter “conductive coils 108a-108d”) in reservoir 102, and control device 140 electrically coupled to at least one of conductive coils 108a-108d. According to the exemplary implementation shown in FIG. 1A, reservoir 102 includes boundary 104 physically and electrically isolating conductive coils 108a-108d from fluid 106.

As further shown in FIG. 1A, system 100A is implemented within a use environment including user 118a providing input 110 to control device 140, or alternatively user 118b utilizing user system 116 and communication network 112 providing network communication links 114 to transmit input 110 to control device 140. In some implementations, communication network 112 may be a packet-switched network such as the Internet, for example. Alternatively, communication network 112 may correspond to one or more of a wide area network (WAN), a local area network (LAN), or another type of private or limited distribution network. Moreover, in some implementations, communication network 112 may be a high-speed network suitable for high performance computing (HPC), for example a 10 GigE network or an Infiniband network.

User system 116 may take the form of a of a personal computing device, such as a desktop computer or any other suitable mobile or stationary computing system that implements data processing capabilities sufficient to support connections to communication network 112. For example, in other implementations, user system 116 may take the form of a laptop computer, tablet computer, or smartphone, for example.

Reservoir 102 may be part of a waterworks attraction such as a fountain or artificial lagoon, for example. In some implementations, reservoir 102 may be configured to produce a constant or variable fluid flow current in fluid 106. Fluid 106 contained by reservoir 102 may be or include a liquid such as water, which may be chlorinated, or glycol or any other liquid having a viscosity substantially similar to water. It is noted that other liquids may be used, but the more viscous the liquid, the less current or energy may travel through it. Conductive coils 108a-108d may be or include copper coils, or coils formed of any other suitable electrically conductive material. It is noted that one advantage of using copper coils as conductive coil(s) 108a-108d is that, in addition to being excellent electrical conductors, copper coils are inexpensive and offer a cost effective solution for implementing the present novel and inventive concepts. It is further noted that although FIG. 1A depicts reservoir 102 as including four conductive coils, that representation is merely exemplary. In other implementations, as few as one conductive coil, or more than four conductive coils may be included in system 100A. It is also noted that although FIG. 1A depicts all of conductive coils 108a-108d as being electrically coupled to control device 140, in other implementations as few as one conductive coil, or some but less than all of conductive coils 108a-108d may be electrically coupled to control device 140.

In some implementations, conductive coils corresponding to conductive coils 108a and 108d may be embedded in the wall boundary of reservoir 102, rockwork or themed environments, so as to surround fluid 106. In other implementations, conductive coils corresponding to conductive coils 108b and 108c may be embedded in the bottom boundary of reservoir 102, underlying fluid 106. In some other implementations conductive coils 108a-108d may be positioned so as to surround fluid 106 and underlie fluid 106, as represented in FIG. 1A, or to be situated above fluid 106, for example in implementations in which reservoir 102 includes a cover (cover not shown in FIG. 1A. In yet other implementations, one or more of conductive coils 108a-108d may move in reservoir 102, i.e., change its location in reservoir 102. However, it is noted that in all implementations, each of conductive coil(s) 108a-108d is physically and electrically isolated from fluid 106, thereby ensuring that the presence of a current in any or all of conductive coil(s) 108a-108d poses no safety risk to a person or animal coming in contact with fluid 106. It should further be noted that, in some implementations, conductive coil(s) 108a-108d operate at a low voltage and low power levels, such as below 100 watts.

Object(s) 120a/120b in physical contact with fluid 106 may be submersible object(s) submerged in fluid 106, and may include a replica of a submarine or a shipwreck, or a synthetic fish or other type of aquatic creature or plant, as represented by submerged object 120a. Alternatively, or in addition, object(s) 120a/120b may be configured to float on fluid 106, and may include a boat or other floating watercraft, or a synthetic plant such as a lily pad or other floating flower, as represented by floating object 120b. Although FIG. 1A depicts two objects in physical contact with fluid 106, that representation is provided merely in the interests of conceptual clarity. In various implementations, object(s) 120a/120b may include as few as one object, or more than two objects, such as dozens of objects, for example, or more.

Furthermore, it is noted that the number of conductive coil(s) 108a-108d in reservoir 102 and the number of object(s) 120a/120b in physical contact with fluid 106 may be the same number, or may differ. For example, in some implementations, reservoir 102 may include a single conductive coil, e.g., one of conductive coil(s) 108a-108d, while a plurality of object(s) 120a/120b are in physical contact with fluid 106. Alternatively, in other implementations a plurality of conductive coil(s) 108a-108d may be present in reservoir 102, while only one object, e.g., object 120a or 120b, may be in physical contact with fluid 106. As yet another alternative, in some implementations, a plurality of conductive coil(s) 108a-108d may be present in reservoir 102, and another, different plurality of object(s) 120a/120b may be in physical contact with fluid 106.

FIG. 1B shows a diagram of system 100B configured to wirelessly deliver power to objects in a fluid environment, according to another exemplary implementation. It is noted that any feature in FIG. 1B identified by a reference number identical to a reference number shown in FIG. 1A corresponds respectively to the feature identified by reference to FIG. 1A and may share any of the characteristics attributed to that corresponding feature by the present disclosure.

As noted above, in some implementations, as few as one conductive coil, or some but less than all of conductive coils in reservoir 102 may be electrically coupled to control device 140. FIG. 1B shows such an implementation in which conductive coil 108e in reservoir 102 is not electrically coupled to control device 140. It is noted that despite not being electrically coupled to control device 140, conductive coil 108e corresponds to any or all of conductive coils 108a-108d and may share any of the characteristics attributed to those corresponding features.

According to the exemplary implementation shown in FIG. 1B, conductive coil 108e may generate an induced current in response to magnetic flux 109 through conductive coil 108e produced by an electric current in conductive coil 108c. As a result, conductive coil 108e, despite not being directly provided with the electric current in conductive coil 108c, may yet effectively extend the range of the magnetic field produced by the electric current in conductive coil 108c.

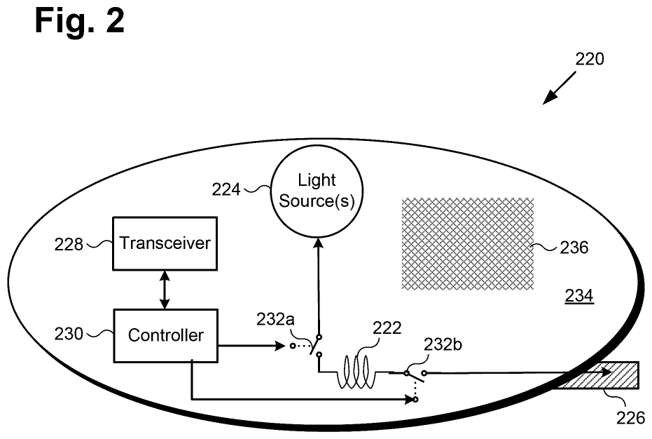

FIG. 2 shows a more detailed diagram of exemplary object 220 configured to receive power in systems 100A and 100B, in respective FIGS. 1A and 1B, according to one implementation. According to the exemplary implementation shown in FIG. 2, object 220 includes induction coil 222 embedded therein, as well as one or more light sources 224 (hereinafter “light source(s) 224”), propulsion device 226, transceiver 228, controller 230 and one or more switches 232a and 232b (hereinafter “switch(es) 232a/232b”). Moreover, and as shown in FIG. 2, object 220 may be formed of translucent material 234, which in some implementations may be doped with ultraviolet (UV) reactive or phosphorescent pigment 236.

It is noted that although FIG. 2 depicts object 220 as including induction coil 222, light source(s) 224, propulsion device 226, transceiver 228, controller 230, switch(es) 232a/232b and translucent material 234 doped with UV reactive or phosphorescent pigment 236, all features except induction coil 222 and propulsion device 226, or induction coil 222, translucent material 234 and light source(s) 224, are optional. For example, in some implementations, object 220 may include as few components as induction coil 222 and propulsion device 226, or may be formed of undoped translucent material 234 and include induction coil 222 and one or more of propulsion device 226 and light source(s) 224. Furthermore, in some implementations, object 220 may include induction coil 222, transceiver 228, controller 230, one of propulsion device 226 or light source(s) 224 selectably coupled to induction coil 222 by respective switch 232a or 232b, or propulsion device 226 and light source(s) 224 selectably coupled to induction coil 222 by respective switches 232a and 232b.

It is further noted that object 220 corresponds in general to either or both of object(s) 120a/120b, in FIGS. 1A and 1B. Consequently, and although not shown in FIGS. 1A and 1B, object(s) 120a/120b may share any of the characteristics attributed to object 220 by the present disclosure, and vice versa. Thus, like object(s) 120a/120b, object 220 is configured to be in physical contact with fluid 106, as either a submersible object or a floating object.

Object 120a/120b/220 may be a translucent object formed of a translucent material in an injection molding process, for example, in which induction coil 222 and one or more of light source(s) 224 or propulsion system 226 are embedded in object 120a/120b/220 during production of object 120a/120b/220. Alternatively, in some implementations, object 120a/120b/220 may be formed using three-dimensional (3-D) printing technology, in which induction coil 222 and light source(s) 224 are embedded in object 120a/120b/220 during production of object 120a/120b/220.

Induction coil 222 may be a small off-the-shelf metal coil capable of providing an induced current sufficient to power light source(s) 224 in the form of one or more light-emitting diodes (LEDs), propulsion device 226 in the form of a miniature motor driving a propeller, for example, or light source(s) 224 and propulsion device 226. For example, induction coil 222 may be a coil capable of providing an induced current in the milliampere (mA) range. It is noted that an advantage of providing induction coil as an embedded feature within object 120a/120b/220 electrically isolated from fluid 106 is that object 120a/120b/220 is free of, i.e., does not include, any exposed electrical contacts capable of introducing electric current into fluid 106.

Light source(s) 224 may include a visible light LED, multiple visible light LEDs emitting different colors, a red-green-blue (RGB) LED capable of emitting multiple colors, one or more UV black light LEDs, or a combination of one or more visible light LEDs and black light LEDs. Moreover, in some implementations, light source(s) 224 may include one or more smart LEDs that are addressable by control device 140. For example, in one implementation, light source(s) 224 may include one or more WS2812B type LEDs. Furthermore, it is noted that in implementations in which object 120a/120b/220 is formed of translucent material 234 doped with UV or phosphorescent pigment 236 and includes light source(s) 224, light source(s) 224 may be temporarily illuminated to activate that pigment, whereupon an internal glow initially produced by light source(s) 224 can be observed to fade or decay after light source(s) 224 is/are extinguished.

Transceiver 228 may be implemented as a wireless communication unit configured for use with one or more of a variety of wireless communication protocols. For example, transceiver 228 may include a fourth generation (4G) wireless transceiver, a 5G wireless transceiver, or 4G and 5G wireless transceivers. In addition, or alternatively, transceiver 228 may be configured for communications using one or more of Wireless Fidelity (Wi-Fi®), Worldwide Interoperability for Microwave Access (WiMAX®), Bluetooth®, Bluetooth® low energy (BLE), ZigBee®, radio-frequency identification (RFID), near-field communication (NFC), and 60 GHz wireless communications methods. Controller 230 may be a microcontroller, for example, configured to execute instructions for controlling object 220 in response to wireless communications received by transceiver 228 from control device 140, in FIGS. 1A and 1B.

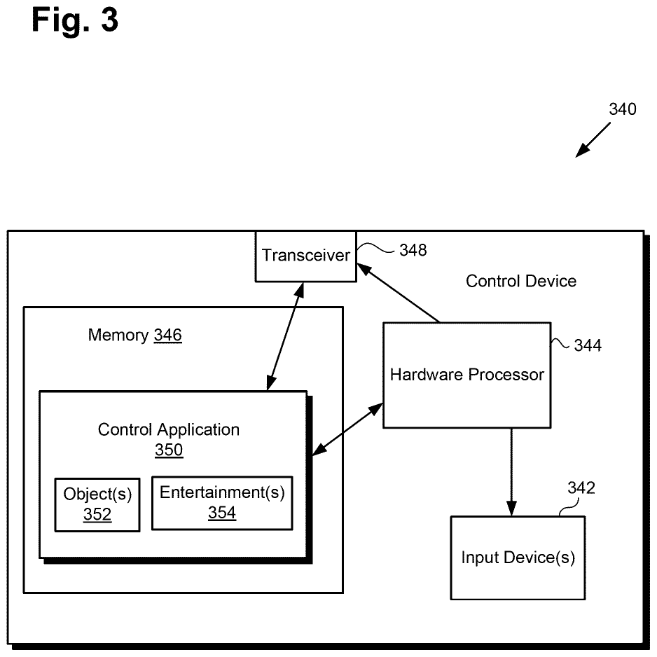

FIG. 3 shows a diagram of exemplary control device 340 suitable for use as part of systems 100A and 100B, in respective FIGS. 1A and 1B, according to one implementation. As shown in FIG. 3, exemplary control device 340 includes one or more input devices 342 (hereinafter “input device(s) 342”), hardware processor 344 and system memory 346 implemented as a computer-readable non-transitory storage medium storing control application 350. In addition, control device 340 includes transceiver 348. Also shown in FIG. 3 are object(s) database 352 including entries describing the properties and capabilities of each of one or more objects corresponding to object(s) 120a/120b/220 in FIGS. 1 and 2, and entertainment(s) library 354 storing instructions describing lighting effects, choreography and the like, for one or more entertainments performed using object(s) 120a/120b/220.

Control device 340 corresponds in general to control device 140, in FIGS. 1A and 1B. In other words, control device 340 may share any of the features attributed to corresponding control device 140 by the present disclosure, and vice versa. Consequently, like control device 140, control device 340 may be electrically coupled to one or more of conductive coil(s) 108a-108d of reservoir 102, in FIG. 1A. Moreover, although not shown in FIGS. 1A and 1B, control device 140 may include features corresponding respectively to input device(s) 342, hardware processor 344, system memory 346 storing control application 350, and transceiver 348.

Input device(s) 342 may include one or more of a keyboard, mouse, trackpad, touchscreen, microphone, infrared (IR) or radio-frequency receiver for reception of inputs via a remote control, or a voice activated input device, to name a few examples.

Hardware processor 344 may be the central processing unit for control device 140/340. By way of definition, as used in the present application, the feature “central processing unit” (CPU) has its customary meaning in the art. That is to say, a CPU includes an Arithmetic Logic Unit (ALU) for carrying out the arithmetic and logical operations of control device 140/340, as well as a Control Unit (CU) for retrieving programs, such as control application 350, from system memory 346.

System memory 346 may take the form of any computer-readable non-transitory storage medium. The expression “computer-readable non-transitory storage medium,” as defined in the present application, refers to any medium, excluding a carrier wave or other transitory signal that provides instructions to hardware processor 344 of control device 140/340. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, internal and external hard drives, optical discs, RAM, programmable read-only memory (PROM), erasable PROM (EPROM) and FLASH memory.

Transceiver 348 may be implemented as a wireless communication unit configured for use with one or more of a variety of wireless communication protocols. For example, like transceiver 228 in FIG. 2, transceiver 348 may include a 4G wireless transceiver, a 5G wireless transceiver, or 4G and 5G wireless transceivers. In addition, or alternatively, transceiver 348 may be configured for communications using one or more of Wi-Fi®, WiMAX®, Bluetooth®, BLE, ZigBee®, RFID, NFC and 60 GHz wireless communications methods. In addition, or alternatively, in some implementations, control device 140/340 may utilize a local area broadcast method, such as User Datagram Protocol (UDP) or Bluetooth®, for instance, to communicate with one or more of user system 116 and objects 120a/120b/220 shown variously in FIGS. 1 and 2.

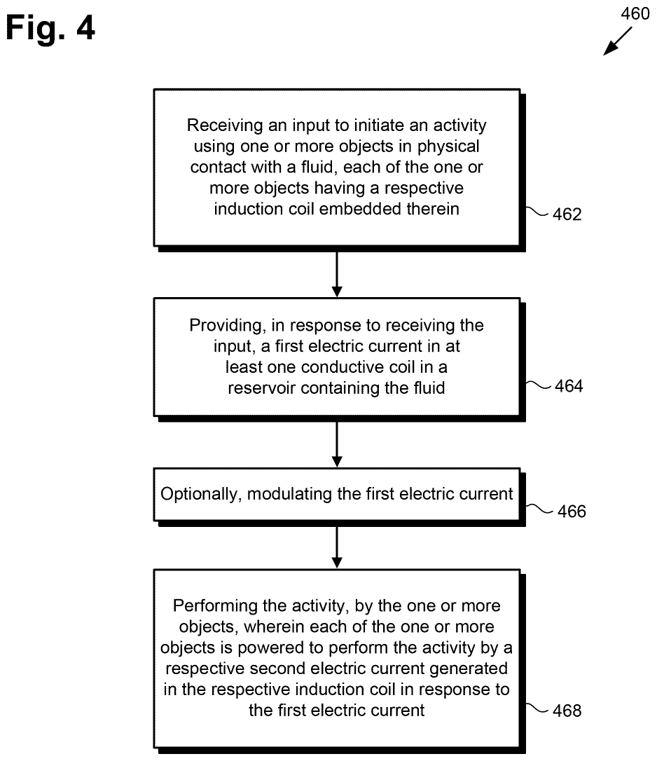

The operation of systems 100A and 100B is further described below by reference to FIG. 4. FIG. 4 shows flowchart 460 presenting an exemplary method for use by a system to wirelessly deliver power to objects in a fluid environment, according to one implementation. With respect to the actions outlined in FIG. 4, it is noted that certain details and features have been left out of flowchart 460 in order not to obscure the discussion of the inventive features in the present application.

Referring to FIG. 4 in combination with FIGS. 1A, 1B, 2 and 3, flowchart 460 includes receiving input 110 to initiate an activity using object(s) 120a/120b/220 in physical contact with fluid 106, each of object(s) 120a/120b/220 having respective induction coil 222 embedded therein (action 462). In some implementations, the activity initiated in response to input 110 may be the illumination of source(s) embedded in object(s) 120a/120b/220, movement by object(s) 120a/120b/220 on or in fluid 106, propulsion of object(s) 120a/120b/220 through fluid 106, or any combination thereof. However, in other implementations, the activity may be an entertainment such as a light show or choreographed movement by object(s) 120a/120b/220 on or in fluid 106.

In some implementations, as noted above by reference to FIG. 1A, input 110 may be received by control device 140/340 directly from user 118a, via input device(s) 342 of control device 140/340. Alternatively, and as also noted above by reference to FIG. 1A, in some implementations input 110 may be received by control device 140/340 of system 100A from user system 116, via communication network 112 and network communication links 114. In either use case, input 110 may be received, in action 462, by control application 350, executed by hardware processor 344 of control device 140/340.

Referring to FIG. 4 in combination with FIGS. 1A, 1B and 3, flowchart 460 further includes providing, in response to receiving input 110, a first electric current in at least one conductive coil (e.g., at least one of conductive coil(s) 108a-108d) in reservoir 102 containing fluid 106 (action 464). As noted above by reference to FIG. 1A, in some implementations, all of conductive coil(s) 108a-108d may be electrically coupled to control device 140/340. In those implementations, the first electric current provided in action 464 may be provided to all of conductive coil(s) 108a-108d.

However, and as further noted above by reference to FIG. 1B, in some implementations, as few as one conductive coil, or some but less than all of conductive coils 108a-108d may be electrically coupled to control device 140/340. In those implementations, conductive coils among conductive coils that are not electrically connected to control device 140/340, such as conductive coil 108e, may generate an induced current in response to magnetic flux 109 through conductive coil 108e produced by the first current in conductive coil 108c. Thus, in some implementations, a conductive coil that is not provided with the first electric current, may yet effectively extend the range of the magnetic field produced by the first electric current provided in action 464. The first electric current may be provided to one or more of conductive coil(s) 108a-108d, in action 464, by control application 350, executed by hardware processor 344 of control device 140/340.

In some implementations, control unit 140/340 may be configured to provide first electric currents of different amperages to conductive coils included among conductive coil(s) 108a-108d. For example, conductive coil 108a may be provided with a first electric current at a first amperage, conductive coil 108b may be provided with the same first electric current or a first electric current of a higher or lower amperage than the first electric current provided to conductive coil 108a, and so forth. By varying the amperages of the first electric currents provided to different conductive coils, different travel paths for object(s) 120a/120b/220 in or on fluid 106 can be produced, different light intensities or illumination patterns emitted by object(s) 120a/120b/220 may be produced, or both variations in travel paths and illumination intensities can be produced.

Continuing to refer to FIG. 4 in combination with FIGS. 1A, 1B and 3, flowchart 460 optionally may further include modulating, during the activity initiated by providing the first electric current in action 464, the first electric current (action 466). It is emphasized that action 466 is optional, and in some implementations may be omitted from the method outlined by flowchart 460. When action 466 is performed, modulating the first electric current may include increasing the first electric current provided in the at least one conductive coil, decreasing that first electric current, or sequentially increasing then decreasing or decreasing then increasing that first electric current. Moreover, in some implementations, modulating the first electric current, in action 466, may include reversing the first electric current. Optional modulation of the first electric current in action 466 may be performed by control application 350, executed by hardware processor 342 of control device 140/340.

Referring to FIG. 4 in combination with FIGS. 1A, 1B, 2 and 3, flowchart 460 further includes performing the activity, by object(s) 120a/120b/220, wherein each of object(s) 120a/120b/220 is powered to perform the activity by a respective second electric current generated in respective induction coil 222 in response to the first electric current (action 468). As noted above, the second current generated in induction coil 222 in response to the first electric current may be an induced current in the mA range.

In some implementations, as also noted above, object(s) 120a/120b/220 may be formed of translucent material 234 and may include induction coil 222 and light source(s) 224 embedded therein. In those implementations, providing the first electric current, in action 464 may result in an increase, a decrease, or alternatingly both an increase and a decrease in the brightness of light emitted by light source(s) 224. Thus, in those implementations, the entertainment may be a light show performed by object(s) 120a/120b/220 using light source(s) 224.

In some implementations, object(s) 120a/120b/220 may include propulsion device 326 in addition to induction coil 222, and in lieu of, or in addition to light source(s) 224. In those implementations, providing the first electric current, in action 464 may further result in object(s) 120a/120b/220 moving faster, slower, alternatively faster and slower, or even reversing the direction of motion or otherwise altering the direction of motion of object(s) 120a/120b/220 on or in fluid 106.

Furthermore, in implementations in which object(s) 120a/120b/220 include transceiver 228 and controller 230, control application 350 may be executed by hardware processor 344 of control device 140/340 to wirelessly control the participation of object(s) 120a/120b/220 used to perform the entertainment in action 468. For example, wireless commands transmitted to object(s) 120a/120b/220 by control device 140/340 may selectively cause switch 232a to close or open, thereby resulting in light source(s) 224 emitting light or going dark. Alternatively, or in addition, wireless commands transmitted to object(s) 120a/120b/220 by control device 140/340 may selectively cause switch 232b to close or open, thereby providing propulsion to object(s) 120a/120b/220 or not.

With respect to the method outlined by flowchart 460, it is also noted that actions 461, 462 and 464, or actions 461, 462, 463, and 464, may be performed as an automated method from which human intervention may be omitted.

Thus, the present application discloses a safe and scalable solution for delivering power to objects in a fluid environment that addresses and overcomes the deficiencies in the conventional art. The novel and inventive concepts disclosed in the present application advance the state-of-the-art by providing a wireless power delivery solution using a primary current in one or more conductive coils of a reservoir containing a fluid to induce a secondary current in a respective induction coil embedded in each object receiving power, and to do so safely. That induced current can be advantageously utilized to illuminate a light source embedded in the object, activate a propulsion device of the object, or illuminate and propel the object in the fluid.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a reservoir containing a fluid;
one or more objects in physical contact with the fluid, each of the one or more objects having a respective induction coil embedded therein;
at least one conductive coil in the reservoir;
a control device having a hardware processor and a memory storing a control application;
the hardware processor configured to execute the control application to:
receive an input to initiate an activity using the one or more objects; and
provide, in response to receiving the input, a first electric current in the at least one conductive coil;
wherein each of the one or more objects is powered by a respective second electric current generated in the respective induction coil of each of the one or more objects, in response to the first electric current, to perform the activity.

2. The system of claim 1, wherein each of the one or more objects includes a respective light source, and wherein the activity comprises a light show performed by the one or more objects.

3. The system of claim 1, wherein the fluid comprises a liquid, and wherein the one or more objects include at least one object submerged in the liquid or floating on the liquid.

4. The system of claim 3, wherein the second electric current powers propulsion of the at least one object through or on the liquid.

5. The system of claim 1, wherein the fluid comprises water.

6. The system of claim 1, wherein the fluid comprises glycol.

7. The system of claim 1, wherein the at least one object comprises a translucent material doped with one of an ultraviolet reactive pigment or a phosphorescent pigment.

8. The system of claim 1, wherein the at least one conductive coil comprises a plurality of conductive coils, and wherein the plurality of conductive coils are located in boundary walls of the reservoir or rockwork surrounding the reservoir.

9. The system of claim 1, wherein the hardware processor is further configured to execute the software code to:
modulate, during the activity, the first electric current.

10. The system of claim 1, wherein the control device and each of the one or more objects further comprise a respective wireless transceiver and wherein the hardware processor is further configured to execute the software code to:
wirelessly control participation of the one or more objects in the activity.

11. A method for use by a system including a reservoir containing a fluid, one or more objects in physical contact with the fluid, each of the one or more objects having a respective induction coil embedded therein, at least one conductive coil in the reservoir, and a control device having a hardware processor and a memory storing a control application, the method comprising:
receiving, by the control application executed by the hardware processor, an input to initiate an activity using the one or more objects;
providing, by the control application executed by the hardware processor in response to receiving the input, a first electric current in the at least one of conductive coil; and
performing the activity, by the one or more objects, wherein each of the one or more objects is powered to perform the activity by a respective second electric current generated in the respective induction coil in response to the first electric current.

12. The method of claim 11, wherein each of the one or more objects includes a respective light source, and wherein the activity comprises a light show performed by the one or more objects.

13. The method of claim 11, wherein the fluid comprises a liquid, and wherein the one or more objects include at least one object submerged in the liquid or floating on the liquid.

14. The method of claim 13, wherein the second electric current powers propulsion of the at least one object through or on the liquid.

15. The method of claim 11, wherein the fluid comprises water.

16. The method of claim 11, wherein the fluid comprises glycol.

17. The method of claim 11, wherein the at least one object comprises a translucent material doped with one of an ultraviolet reactive pigment or a phosphorescent pigment.

18. The method of claim 11, wherein the at least one conductive coil comprises a plurality of conductive coils, and wherein the plurality of coils are located in boundary walls of the reservoir or rockwork surrounding the reservoir.

19. The method of claim 11, further comprising:
modulating, by the control application executed by the hardware processor during the activity, the first electric current.

20. The method of claim 11, wherein the control device and each of the one or more objects further comprise a respective wireless transceiver, the method further comprising:
wirelessly controlling, by the control application executed by the hardware processor, participation of the one or more objects in the activity.
